(19) United States
(12) Patent Application Publication
(10) Pub. No.: US 2014/0066357 A1
(43) Pub. Date: Mar. 6, 2014

(54) HEAT-STABLE MICROENCAPSULATED FRAGRANCE OILS

(71) Applicants: Peter C. YAO, Pickerington, OH (US); Clark A. COOK, Kingston, OH (US)

(72) Inventors: Peter C. YAO, Pickerington, OH (US); Clark A. COOK, Kingston, OH (US)

(73) Assignee: P. H. GLATFELTER COMPANY, York, PA (US)

(21) Appl. No.: 13/599,686

(22) Filed: Aug. 30, 2012

(51) Int. Cl. C11D 3/50

(52) U.S. Cl. CPC C11D 3/505
USPC 512/2

(57) ABSTRACT

A process is disclosed to make polyurea microcapsules containing fragrance oil. The microcapsules are heat stable such that the fragrance substantially remains when the microcapsules are exposed for 1 hour at a temperature of from about 190° F. to about 240° F.

### BACKGROUND OF THE INVENTION

The present invention provides heat-stable microencapsulated fragrance oils for use in a variety of applications. In particular, the present invention provides a process for making heat-stable microencapsulated fragrance oils by employing certain protective colloids during an interfacial polymerization technique.

The background of the present invention will be described in connection with its use with encapsulation of fragrances. It should be understood, however, that the use of the present invention has wider applicability as described hereinafter. There are almost limitless applications for microencapsulated materials. For example, microencapsulated materials are utilized in agriculture, pharmaceuticals, foods (e.g., flavor delivery), cosmetics, laundry, textiles, paper, paints, coatings and adhesives, printing applications, and many other industries.

Microencapsulation is a process in which tiny particles or droplets are surrounded by a coating to create small capsules around the droplets. Thus, in a relatively simplistic form, a microcapsule is a small sphere with a uniform wall around it. The substance that is encapsulated may be called the core material, the active ingredient or agent, fill, payload, nucleus, or internal phase. The material encapsulating the core is referred to as the coating, membrane, shell, or wall material. Microcapsules may have one wall or multiple shells arranged in strata of varying thicknesses around the core. Most core/shell microcapsules have diameters between 1 μm and 100 μm.

Microencapsulation has been employed as a means to protect fragrances or other active agents from, for example, oxidation caused by heat, light, humidity, and exposure to other substances over their lifetime. Microencapsulation has also been used to prevent evaporation of volitile compounds and to control the rate of release by many actions such as, for example, mechanical, temperature, diffusion, pH, biodegradation, and dissolution means.

Microencapsulation may be achieved by a myriad of techniques, with several purposes in mind. Substances may be microencapsulated with the intention that the core material be confined within capsule walls for a specific period of time. Alternatively, core materials may be encapsulated so that the core material will be released either gradually through the capsule walls, known as controlled release or diffusion, or when external conditions trigger the capsule walls to rupture, melt, or dissolve.

A preferred microencapsulation means in the context of the present invention involves an interfacial polymerization employing an oil-in-water emulsion. Interfacial polymerization (IFP) is characterized by wall formation via the rapid polymerization of monomers at the surface of the droplets or particles of dispersed core material. A multifunctional monomer is dissolved in the core material, and this solution is dispersed in an aqueous phase. A reactant to the monomer is added to the aqueous phase, and polymerization quickly ensues at the surfaces of the core droplets, forming the capsule walls. IFP can be used to prepare bigger microcapsules depending on the process, but most commercial IFP processes produce smaller capsules in the 20-30 μm or even smaller, for example, 3-6 μm.

Fragrances and perfumes, in general, possess terminal groups such as —OH, —NH, —C═O, —CHO, or —COOH. Their partial solubility in water leads to great instability in the microencapsulation interfactial polymerization reactions. These chemical groups tend to surround the wall of the microcapsule, modifying the hydrolytic stability of the particle and destabilizing the polymerization reaction. Moreover, these groups can react with the monomers during interfacial polymerization, leading to microcapsule formation that might modify the properties of fragrances and purfumes.

These problems with encapsulating fragrances have been at least partially rectified by employing polyurea systems to form the shell of the microcapsule. Another benefit to using polyurea systems is their versatility in that they can be tailor-made from a wide range of raw materials in order to achieve the desired chemical and mechanical properties.

Microcapsules having walls made of polyurea are prepared by a two-phase polyaddition process. To this end, an oil phase containing an organic water-immiscible inert solvent, polyisocyanate and the material to be encapsulated is emulsified in an aqueous phase containing water and, if desired, additives such as emulsifiers, stabilizers and/or materials for preventing coalescence. The addition of a polyamine or an amino alcohol to this emulsion initiates a polyaddition reaction of amino and/or hydroxyl groups with isocyanate groups at the interface between oil droplets and water phase. As a result thereof, the oil droplets are enveloped by a polyurea or polyurea/polyurethane wall. This gives a dispersion of microcapsules containing the material to be encapsulated and the organic solvent. The size of the microcapsules is approximately equal to the size of the emulsified oil droplets.

Microencapsulated fragrance oils are particularly effective when employed in fabric softeners and detergents to boost fragrance intensity and extend scents to several days. Problems associated with polyurea encapsulation technology for fragrance oils include insufficient high temperature resistance (190° F. to 240° F.) that make them problematic for use in dryers when incorporated into, for example, fabric softener liquid or non-woven sheets. Accordingly, there is a need in the art for polyurethan-urea microencapsulated fragrance oils for use in high temperature applications.

### BRIEF SUMMARY OF THE INVENTION

The present invention satisfies this need by providing a process for preparing a thermally stable microencapsulated oil-based core material, the process comprising the steps of: a) mixing at least one first prepolymer with an oil-based core material, wherein the prepolymer is selected from the group consisting of an isocyanate, a diisocyanate, and a mixture thereof; b) dissolving at least one second prepolymer in water to form a second prepolymer aqueous solution, wherein the at least one second prepolymer is an amine having at least two function groups, c) dissolving in water a protective colloid selected from the group consisting of soy protein, gelatin type B, gum acacia, gelatin type A, and mixtures thereof, to form a protective colloid solution; d) adding the mixture of the oil-based core material and the at least one first prepolymer to the protective colloid solution and forming an emulsion; e) adding the second prepolymer aqueous solution to the emulsion to initiate polymerization with the at least one first prepolymer under aggitation at a temperature of from about 140° F. to 176° F. thus forming at least one layer of a polymeric shell around the first polymeric shell of the microcapsules; and f) cooling the microcapsules, wherein the microcapsules exhibit a fragrance, and wherein the fragrance substantially remains when the microcapsules are exposed for 1 hour at a temperature of from about 190° F. to about 240° F.

In another aspect, the present invention a microcapsule formulation comprising, microcapsules of an average diameter of from 1 to 100 μm, having a core of an oil-based fragrance core material and a polyurea shell, wherein the microcapsules are obtained by a process comprising: a) mixing at least one first prepolymer with an oil-based core material, wherein the prepolymer is selected from the group consisting of an isocyanate, a diisocyanate, and a mixture thereof; b) dissolving at least one second prepolymer in water to form a second prepolymer aqueous solution, wherein the at least one second prepolymer is an amine having at least two function groups, c) dissolving in water a protective colloid selected from the group consisting of soy protein, gelatin type B, gum acacia, gelatin type A, and mixtures thereof, to form a protective colloid solution; d) adding the mixture of the oil-based core material and the at least one first prepolymer to the protective colloid solution and forming an emulsion; e) adding the second prepolymer aqueous solution to the emulsion to initiate polymerization with the at least one first prepolymer under aggitation at a temperature of from about 140° F. to 176° F. thus forming at least one layer of a polymeric shell around the first polymeric shell of the microcapsules; and f) cooling the microcapsules, wherein the microcapsules exhibit a fragrance, and wherein the fragrance substantially remains when the microcapsules are exposed for 1 hour at a temperature of from about 190° F. to about 240° F.

### DETAILED DESCRIPTION OF THE INVENTION

The present invention provides polyurea microencapsulated fragrance oils that are heat resistant in that they are suitable for use in applications where the microcapsules are exposed for about one hour to temperatures in the range of from about 190° F. to about 240° F. such as, for example, in a dryer for laundry applications.

The process of producing such thermally stable microcapsules according to the present invention comprises the steps of: mixing at least one first prepolymer with an oil-based core material, wherein the prepolymer is selected from the group consisting of an isocyanate, a diisocyanate, and a mixture thereof; dissolving at least one second prepolymer in water to form a second prepolymer aqueous solution, wherein the at least one second prepolymer is an amine having at least two function groups; dissolving in water a protective colloid selected from the group consisting of soy protein, gelatin type B, gum acacia, gelatin type A, and mixtures thereof, to form a protective colloid solution; adding the mixture of the oil-based core material and the at least one first prepolymer to the protective colloid solution and forming an emulsion; adding the second prepolymer aqueous solution to the emulsion to initiate polymerization with the at least one first prepolymer under aggitation at a temperature of from about 140° F. to 176° F. thus forming at least one layer of a polymeric shell around the first polymeric shell of the microcapsules; and cooling the microcapsules.

The process of the present invention includes the step of forming a hydrophobic or oil phase of an emulsion by mixing at least one first prepolymer with an oil-based core material, wherein the first prepolymer is selected from the group consisting of an isocyanate, a diisocyanate, and a mixture thereof. Preferably, according to the present invention the oil-based core is a fragrance oil to be encapsulated by the process. As used herein, the term “frangence oil” includes perfumes and a variety of fragrance materials of both natural and synthetic origins whose scent is recognized by a person of ordinary skill in the art as being able to impart or modify in a positive or pleasant way the odor of a composition. Fragrance oils may include single compounds and mixtures of compounds. Specific examples of such compounds include perfuming ingredients belonging to varied chemical groups such as alcohols, aldehydes, ketones, esters, acetates, nitrites, terpenic hydrocarbons, heterocyclic nitrogen- or sulfur-containing compounds, as well as natural or synthetic oils.

Examples of fragrance oils useful herein include, but are not limited to, animal fragrances such as musk oil, civet, castoreum, ambergris, plant fragrances such as nutmeg extract, cardomon extract, ginger extract, cinnamon extract, patchouli oil, geranium oil, orange oil, mandarin oil, orange flower extract, cedarwood, vetyver, lavandin, ylang extract, tuberose extract, sandalwood oil, bergamot oil, rosemary oil, spearmint oil, peppermint oil, lemon oil, lavender oil, citronella oil, chamomille oil, clove oil, sage oil, neroli oil, labdanum oil, eucalyptus oil, verbena oil, mimosa extract, narcissus extract, carrot seed extract, jasmine extract, olibanum extract, rose extract and mixtures thereof.

Other examples of suitable fragrance oils include, but are not limited to, chemical substances such as acetophenone, adoxal, aldehyde C₁₂, aldehyde C₁₄, aldehyde C₁₈, allyl caprylate, ambroxan, amyl acetate, dimethylindane derivatives, α-amylcinnamic aldehyde, anethole, anisaldehyde, benzaldehyde, benzyl acetate, benzyl alcohol and ester derivatives, benzyl propionate, benzyl salicylate, borneol, butyl acetate, camphor, carbitol, cinnamaldehyde, cinnamyl acetate, cinnamyl alcohol, cis-3-hexanol and ester derivatives, cis-3-hexenyl methyl carbonate, citral, citronnellol and ester derivatives, cumin aldehyde, cyclamen aldehyde, cyclo galbanate, damascones, decalactone, decanol, estragole, dihydromyrcenol, dimethyl benzyl carbinol, 6,8-dimethyl-2-nonanol, dimethyl benzyl carbinyl butyrate, ethyl acetate, ethyl isobutyrate, ethyl butyrate, ethyl propionate, ethyl caprylate, ethyl cinnamate, ethyl hexanoate, ethyl valerate, ethyl vanillin, eugenol, exaltolide, fenchone, fruity esters such as ethyl 2-methyl butyrate, galaxolide, geraniol and ester derivatives, helional, 2-heptonone, hexenol, α-hexylcinnamic aldehyde, hydroxycitrolnellal, indole, isoamyl acetate, isoeugenol acetate, ionones, isoeugenol, isoamyl iso-valerate, limonene, linalool, lilial, linalyl acetate, lyral, majantol, mayol, melonal, menthol, p-methylacetophenone, methyl anthranilate, methyl cedrylone, methyl dihydrojasmonate, methyl eugenol, methyl ionone, methyl-β-naphthyl ketone, methylphenylcarbinyl acetate, mugetanol, γ-nonalactone, octanal, phenyl ethyl acetate, phenyl-acetaldehyde dimethyl acetate, phenoxyethyl isobutyrate, phenyl ethyl alcohol, pinenes, sandalore, santalol, stemone, thymol, terpenes, triplal, triethyl citrate, 3,3,5-trimethylcyclohexanol, γ-undecalactone, undecenal, vanillin, veloutone, verdox and mixtures thereof. Preferred fragrance oils for use according to the present invention include limonene, and various commercial blends such as, for example, APRIL FRESH™ fragrance oil (available from Arylessence, Marietta, Ga.) and FLORACAPS FRESH™ (available from Colgate-Palmolive Company, Bois Colombes, France).

As used herein, the term “prepolymer” refers to a chemical component that is capable of reacting with at least one other prepolymer or another of its kind as to enable formation of the polymer. Because the present invention is primarily directed to polyurea or polurethane containing microcapsule shells, then at least one first prepolymer according to the present invention is selected from the group consisting of an isocyanate, a diisocyanate, and a mixture thereof. According to an embodiment of the present invention, the at least one first prepolymer is a C₈₋₂₀ bis-isocyanate. Specific but non-limiting examples of such bis-isocyanates include isophorone diisocyanate (IPDI), hexamethylene diisocyanate (HDI), toluene diisocyanate (TDI), methylene-bis-(4-cyclohexylisocynate) (HMDI), xylene diisocynate (XDI), methylene diphenyl diisocynate (MDI), and mixtures thereof.

The process of the present invention includes the step of dissolving at least one second prepolymer in water to form a second prepolymer aqueous solution, wherein the at least one second prepolymer is an amine having at least two function groups. The second prepolymer may also be referred to herein as a “cross linker.” Suitable such amines include aliphatic primary, secondary, or tertiary amines such as 1,2-ethylene diamine, bis-(3-aminopropyl)-amine, hydrazine, hydrazine-2-ethanol, bis-(2-methylaminoethyl)-methyl amine, 1,4-diaminocyclohexane, 3-amino-1-methylaminopropane, N-hydroxyethyl ethylene diamine, N-methyl-bis-(3-aminopropyl)-amine, 1,4-diamino-n-butane, 1,6-diamino-n-hexane, 1,2-ethylene diamine-N-ethane sulphonic acid (in the form of an alkali metal salt), 1-aminoethyl-1,2-ethylene diamine, bis-(N,N′-aminoethyl)-1,2-ethylene diamine, and diethylenetriamine. Hydrazine and its salts are also regarded as diamines in the present context. The following polyisocyanates are particularly preferred and include hexamethylene diisocyanate, isophorone diisocyanate and/or derivatives of hexamethylene diisocyanate and of isophorone diisocyanate having free isocyanate groups, and mixtures thereof.

Other suitable amines for use as the second prepolymer according to the present invention include guanidine compounds wherein the guanidine compounds have at least two functional groups. Examples of guanidine compounds which are suitable for preparing the microcapsules according to the invention are those of the formula (I)

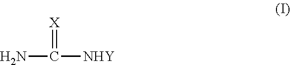

in which X represents HN═,

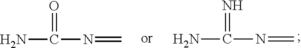

and Y represents H—, NC—, H₂N—, HO—,

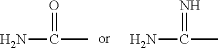

and salts thereof with acids.

For example, the salts can be salts of carbonic acid, nitric acid, sulphuric acid, hydrochloric acid, silicic acid, phosphoric acid, formic acid and/or acetic acid. Salts of guanidine compounds of the formula (I) can be used in combination with inorganic bases in order to obtain the free guanidine compounds of the formula (I) in situ from the salts. Examples of inorganic bases which are suitable for this purpose are alkali metal hydroxides and/or alkaline earth metal hydroxides and/or alkaline earth metal oxides. Preference is given to aqueous solutions or slurries of these bases, in particular to aqueous sodium hydroxide solution, aqueous potassium hydroxide solution and aqueous solutions or slurries of calcium hydroxide. Combinations of a plurality of bases can also be used.

It is often advantageous to use the guanidine compounds of the formula (I) as salts because they are commercially available in this form and some of the free guanidine compounds are sparingly soluble in water or are not stable on storage. If inorganic bases are used, they can be employed in stoichiometric, less than stoichiometric and more than stoichiometric amounts, relative to the salts of guanidine compounds. It is preferred to use 10 to 100 equivalent % of inorganic base (relative to the salts of guanidine compounds). The addition of inorganic bases has the effect that during microencapsulation guanidine compounds having free NH₂ groups are available in the aqueous phase for the reaction with the polyisocyanates present in the oil phase. During microencapsulation, the addition of salts of guanidine compounds and of bases is advantageously carried out such that they are added separately to the aqueous phase.

Preference is given to the use of guanidine or salts of guanidine with carbonic acid, nitric acid, sulphuric acid, hydrochloric acid, silicic acid, phosphoric acid, formic acid and/or acetic acid.

It is particularly advantageous to use salts of guanidine compounds with weak acids. In aqueous solution these salts are, as a result of hydrolysis, in equilibrium with the corresponding free guanidine compound. The free guanidine compound is consumed during the encapsulation process. This advantage is especially observed with guanidine carbonate. When salts of guanidine compounds with weak acids are used, no inorganic bases for releasing the free guanidine compounds need to be added.

Guanidine carbonate is the preferred guanidine compound for use in accordance with the present invention.

The guanidine compounds of the formula (I) which are suitable for the present invention can be prepared by ion exchange from their water-soluble salts by prior art methods using commercially available basic ion exchangers. The eluate from the ion exchanger can be used directly for producing the capsule wall by mixing it with the oil-in-water emulsion.

The concentration of guanidine compound in the aqueous guanidine solutions of the present invention is not critical and is in general only limited by the solubility of the guanidine compounds in water. For example, 1% to 20% strength by weight aqueous solutions of guanidine compounds are suitable.

The process of the present invention includes the step of dissolving in water a protective colloid selected from the group consisting of soy protein, gelatin type B, gum acacia, gelatin type A, and mixtures thereof, to form an aqueous protective colloid solution. Although it is common to use protective colloids and/or emulsifiers in interfacial microemcapsulation processes, it has been found that use of the soy protein, gelatin type B, gum acacia, gelatin type A, and mixtures thereof as protective colloids has surprisingly resulted in microcapsules that exhibit thermal resistance in that they can withstand temperatures of from about 190° F. to about 240° F. for 1 hour, without exhausting their ability to release the fragrance oil. The protective colloids are generally added in amounts of from 0.1 to 10% by weight, based on the water phase of the emulsion. The thermal resistance of the resultant microcapsules can be characterized by the level of intensity of the fragrance after the hour at such elevated temperature as is explained in more detail in the examples that follow.

The process of the present invention includes the step of adding the mixture of the oil-based core material and the at least one first prepolymer to the aqueous protective colloid solution and forming an emulsion. To produce the microcapsules, the oil phase comprising the at least one first prepolymer (e.g., diisocyanate) and the oil-based core material (e.g., fragrance oil) are mixed with the aqueous protective colloid solution and emulsified in an aqueous phase. The emulsion can be made by any method known to those skilled in the art. For example, once all of the ingredients for making the emulsion are admixed, the resulting emulsion or combination of ingredients may be run through a homogenizer. The homogenizer total stage pressure may be from about 1 psig to about 30,000 psig (about 7 kPa to about 206850 kPa), generally at least about 2,000 psig (13790 kPa), preferably from about 4,000 psig to about 10,000 psig (about 27580 kPa to about 68950 kPa), most preferably from about 5,000 psig to about 7,000 psig (about 34475 kPa to about 48265 kPa). The homogenization may be performed in one or more stages, using one or more passes through each stage. For example, two stages and three passes may be employed for the homogenization step. In other embodiments, there may be as many as four discrete passes of the emulsion through the homogenizer, but more preferably there are two to three passes. This process can produce a stable emulsion with droplet sizes less than about 2.1 microns (90 percentile), preferably less than about 1 micron (90 percentile). It is preferable to minimize heat exposure during homogenization as much as possible and to keep a nitrogen blanket on all emulsion containers.

The process of the present invention includes the step of adding the second prepolymer aqueous solution to the emulsion to initiate polymerization with the at least one first prepolymer under aggitation at a temperature of from about 140° F. to 176° F. thus forming at least one layer of a polymeric shell around the first polymeric shell of the microcapsules. The amount of the second prepolymer should be sufficient to react with the remaining NCO groups of the first prepolymer. This reaction step is preferably heated to from about 140° F. to 176° F. under aggitation for at least two hours.

The process of the present invention also includes the step of cooling the microcapsules. Once the reaction is complete, the microcapsule-containing mixture can be allowed to cool to, for example, room temperature by simply removing the heat source or via a heat exchanger device known to those skilled in the art.

Microcapsules according to the invention can be produced by continuous and batchwise methods. The continuous procedure can be such, for example, that an emulsion of the desired type and oil droplet size is produced continuously in an emulsifying machine by the flow-through method. This can be followed by continuous addition of an aqueous solution of the amine in a downstream reaction vessel.

The batchwise procedure can be such, for example, that the aqueous amine solution is added to an emulsion containing oil droplets having approximately the size of the desired microcapsules at the desired temperature in such an amount as is required stoichiometrically for the reaction of all isocyanate groups present in the oil phase.

The components of the emulsion can be mixed together in various ratios. According to one embodiment of the invention, the oil-based core material may account for between 30 and 95%, more preferably for between 60 and 90%, of the total weight of the dry capsules obtained by the process of the present invention.

The microcapsules of the present invention possess a number of advantages. By employing the above-recited protective colloids the resulting microcapsules have excellent high temperature resistance in that the core fragrance oil is not quickly released under high temperatures (i.e., from about 190° F. to about 240° F.) even when held for 1 hour.

The microcapsules made by the process of the present invention preferably have an average diameter of from 1 to 100 μm.

The microcapsules of the present invention can be incorporated in a nonwoven substrate for use, for example, as a fabric softener sheet for a dryer to impart fragrance into clothing articles.

The following examples are provided for the purpose of further illustrating the present invention but are by no means intended to limit the same.

### EXAMPLES

### Preparation of External Phase (EP) (Shell)

216 grams of distilled water were added to a 600-mL glass beaker. The beaker was placed on a laboratory hot plate with a magnetic stirrer. 2.2 grams of the protective colloid listed in the Tables I and II below were added into the distilled water under heat and agitation until dissolved. The solution of cooled and set aside.

### Preparation of Internal Phase (IP)

To a separate 600-mL glass beaker, 145.5 grams of fragrance oil (Floracaps Fresh (#29058) Supplied by Colgate Palmolive) was added. 36.4 grams of polyisocyanate were added into the oil under agitation until a uniform mixture was obtained.

### Preparation of Polyamine Solution

11.3 grams of guanidine carbonate (GUCA) were dissolved in 45.3 grams of distilled water under agitation.

### Preparation of Emulsion

IP was slowly added to the EP and emulsified to 15- to 30-micron diameter emulsion using a laboratory homogenizer (ULTRA-TURRAX T-50, manufactured by IKA) at 3,500 rpm for 30 seconds.

### Microcapsule Wall Formation

The polyamine solution was added to the emulsion under agitation using an overhead laboratory mixer (IKA RW-16 Basic). 75 to 80 grams of water were added to the batch and the temperature was gradually increased to 176° F. and held for 3 hours. At the end of 3 hours, the heat was turned off and mixing continued until the batch was cooled to room temperature. 0.3% of a suspension aid such as Cellulon PX was added to prevent creaming and phase separation.

### Application/Performance

Nonwoven substrates soaked with microencapsulated April Fresh 10C fragrance oil from Arylessence (0.1% in DI water) were exposed to 240° F. for 1 hour then tested for fragrance burst by rubbing the nonwoven substrates.

The following procedure was employed: 0.35% microcapsules (on a dry bass) containing fragrance. The 0.35% represents fragrance oil to total sample capsule slurry weight. The solution was then sprayed onto a 6″×12″ nonwoven standard style shop towels, 15 sprays or approximately 20 grams (saturated) and oven dried followed by rubbing the sides of the towel together and sniffed. The scale used to characterize the samples is the industry standard 1 to 10 scale wherein 1 is the least intense and 10 is the most intense. It is understood by those skilled in the art that a value of 6 or better would signify that substantially all of the fragrance remains after 1 hour in the oven at a temperature of from about 190° F. to about 240° F.

As shown in Table I below versus Table II (comparative), microcapsules made with gum Acacia and proteins had superior high temperature resistance in that after such exposure, the nonwoven substrates still exhibited fragrance burst, i.e., substantially all of the fragance remained.

TABLE 1

| | Batch #2 | Batch #3 | Batch #4 | Batch #5 |
|---|---|---|---|---|
| Protective | Soy | Gelatin | Gum | Gelatin |
| colloid | Protein | Type B | Acacia | Type A |
| No Friction* | 2 | 2 | 2 | 2 |
| Friction* | 8 | 8 | 8 | 8 |
| Delta* | 6 | 6 | 6 | 6 |

TABLE 2

| | Batch #6 | Batch #7 | Batch #8 | Batch #9 |
|---|---|---|---|---|
| Protective | Poval | Whey | Casein | PVOH |
| colloid | C-506 | Protein | | |
| No Friction* | 1 | 1 | 1 | 1 |
| Friction* | 1 | 3 | 1 | 1 |
| Delta* | 0 | 2 | 0 | 0 |

*Ratings are from 1 to 10, with 10 being best.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

1. A process for preparing a thermally stable microencapsulated oil-based core material, the process comprising the steps of:
a) mixing at least one first prepolymer with an oil-based core material, wherein the prepolymer is selected from the group consisting of an isocyanate, a diisocyanate, and a mixture thereof;
b) dissolving at least one second prepolymer in water to form a second prepolymer aqueous solution, wherein the at least one second prepolymer is an amine having at least two function groups,
c) dissolving in water a protective colloid selected from the group consisting of soy protein, gelatin type B, gum acacia, gelatin type A, and mixtures thereof, to form a protective colloid solution;
d) adding the mixture of the oil-based core material and the at least one first prepolymer to the protective colloid solution and forming an emulsion;
e) adding the second prepolymer aqueous solution to the emulsion to initiate polymerization with the at least one first prepolymer under aggitation at a temperature of from about 140° F. to 176° F. thus forming at least one layer of a polymeric shell around the first polymeric shell of the microcapsules; and
f) cooling the microcapsules,
wherein the microcapsules exhibit a fragrance, and wherein the fragrance substantially remains when the microcapsules are exposed for 1 hour at a temperature of from about 190° F. to about 240° F.

2. The process of claim 1 wherein the oil-based core material is fragrance oil.

3. The process of claim 1 wherein the at least one first prepolymer is a C₈₋₂₀ bis-isocyanate.

4. The process of claim 3 wherein the bis-isocyanates are selected from the group consisting of isophorone diisocyanate (IPDI), hexamethylene diisocyanate (HDI), toluene diisocyanate (TDI), methylene-bis-(4-cyclohexylisocynate) (HMDI), xylene diisocynate (XDI), methylene diphenyl diisocynate (MDI), and mixtures thereof.

5. The process of claim 1 wherein the amine is selected from the group consisting of 1,2-ethylene diamine, bis-(3-aminopropyl)-amine, hydrazine, hydrazine-2-ethanol, bis-(2-methylaminoethyl)-methyl amine, 1,4-diaminocyclohexane, 3-amino-1-methylaminopropane, N-hydroxyethyl ethylene diamine, N-methyl-bis-(3-aminopropyl)-amine, 1,4-diamino-n-butane, 1,6-diamino-n-hexane, 1,2-ethylene diamine-N-ethane sulphonic acid (in the form of an alkali metal salt), 1-aminoethyl-1,2-ethylene diamine, bis-(N,N′-aminoethyl)-1,2-ethylene diamine, and diethylenetriamine.

6. The process of claim 1 wherein the amine is a guanidine compound.

7. The process of claim 1 wherein the guanidine compound is of the formula (I) 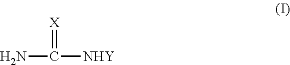
in which X represents HN═, 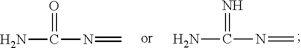
and Y represents H—, NC—, H₂N—, HO—, 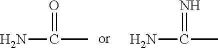
and acid salts thereof.

8. The process of claim 7 wherein guanidine compound is a salt of an acid selected from the group consisting of carbonic acid, nitric acid, sulphuric acid, hydrochloric acid, silicic acid, phosphoric acid, formic acid and/or acetic acid.

9. The process of claim 8 wherein the guanidine compound is guanidine carbonate.

10. The process of claim 1 wherein the protective colloid is soy protein.

11. The process of claim 1 wherein the protective colloid is gelatin type B.

12. The process of claim 1 wherein the protective colloid is gum acacia.

13. The process of claim 1 wherein the protective colloid is gelatin type A.

14. A microcapsule formulation comprising, microcapsules of an average diameter of from 1 to 100 μm, having a core of an oil-based fragrance core material and a polyurea shell, wherein the microcapsules are obtained by a process comprising:
a) mixing at least one first prepolymer with an oil-based core material, wherein the prepolymer is selected from the group consisting of an isocyanate, a diisocyanate, and a mixture thereof;
b) dissolving at least one second prepolymer in water to form a second prepolymer aqueous solution, wherein the at least one second prepolymer is an amine having at least two function groups,
c) dissolving in water a protective colloid selected from the group consisting of soy protein, gelatin type B, gum acacia, gelatin type A, and mixtures thereof, to form a protective colloid solution;
d) adding the mixture of the oil-based core material and the at least one first prepolymer to the protective colloid solution and forming an emulsion;
e) adding the second prepolymer aqueous solution to the emulsion to initiate polymerization with the at least one first prepolymer under aggitation at a temperature of from about 140° F. to 176° F. thus forming at least one layer of a polymeric shell around the first polymeric shell of the microcapsules; and
f) cooling the microcapsules,
wherein the microcapsules exhibit a fragrance, and wherein the fragrance substantially remains when the microcapsules are exposed for 1 hour at a temperature of from about 190° F. to about 240° F.

15. The formulation of claim 14 wherein the oil-based core material is fragrance oil.

16. The formulation of claim 14 wherein the at least one first prepolymer is a C₈₋₂₀ bis-isocyanate.

17. The formulation of claim 16 wherein the bis-isocyanates are selected from the group consisting of isophorone diisocyanate (IPDI), hexamethylene diisocyanate (HDI), toluene diisocyanate (TDI), methylene-bis-(4-cyclohexylisocynate) (HMDI), xylene diisocynate (XDI), methylene diphenyl diisocynate (MDI), and mixtures thereof.

18. The formulation of claim 14 wherein the amine is selected from the group consisting of 1,2-ethylene diamine, bis-(3-aminopropyl)-amine, hydrazine, hydrazine-2-ethanol, bis-(2-methylaminoethyl)-methyl amine, 1,4-diaminocyclohexane, 3-amino-1-methylaminopropane, N-hydroxyethyl ethylene diamine, N-methyl-bis-(3-aminopropyl)-amine, 1,4-diamino-n-butane, 1,6-diamino-n-hexane, 1,2-ethylene diamine-N-ethane sulphonic acid (in the form of an alkali metal salt), 1-aminoethyl-1,2-ethylene diamine, bis-(N,N′-aminoethyl)-1,2-ethylene diamine, and diethylenetriamine.

19. The formulation of claim 14 wherein the amine is a guanidine compound.

20. The formulation of claim 14 wherein the guanidine compound is of the formula (I) 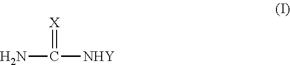
in which X represents HN═, 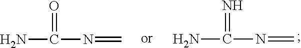
and Y represents H—, NC—, H₂N—, HO—, 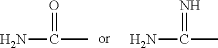
and acid salts thereof.

21. The formulation of claim 20 wherein guanidine compound is a salt of an acid selected from the group consisting of carbonic acid, nitric acid, sulphuric acid, hydrochloric acid, silicic acid, phosphoric acid, formic acid and/or acetic acid.

22. The formulation of claim 21 wherein the guanidine compound is guanidine carbonate.

23. The formulation of claim 14 wherein the protective colloid is soy protein.

24. The formulation of claim 14 wherein the protective colloid is gelatin type B.

25. The formulation of claim 14 wherein the protective colloid is gum acacia.

26. The formulation of claim 14 wherein the protective colloid is gelatin type A.
